(19) United States
(12) Patent Application Publication
(10) Pub. No.: US 2012/0131808 A1
(43) Pub. Date: May 31, 2012

(54) APPARATUS AND METHOD FOR VALVE LASH ADJUSTMENT

(75) Inventors: Michael Spencer, Ravenfield (GB); Jacob Moore, Cromwell, CT (US); Sujayakumar Kuppuswamy, Bangalore (IN)

(73) Assignee: Jacobs Vehicle Systems, Inc., Bloomfield, CT (US)

(21) Appl. No.: 13/299,649

(22) Filed: Nov. 18, 2011

Related U.S. Application Data
(60) Provisional application No. 61/416,155, filed on Nov. 22, 2010.

(51) Int. Cl. G01D 21/00

(52) U.S. Cl. 33/611

(57) ABSTRACT

Methods and apparatus for setting a lash space between a lost motion piston and an engine valve or other components of an internal combustion engine are disclosed. The apparatus may include a lock nut gauge, a zero setting gauge extending into the lock nut gauge, a lash setting gauge extending into the zero setting gauge, and a bit stem extending through the lash setting gauge. The bit stem may include a bit which is used to rotate a tappet screw that sets the lash. A key extending between the zero setting gauge and a scroll channel in the lash setting gauge may be used to control setting of the tappet screw, and thus the setting of lash.

### CROSS REFERENCE TO RELATED APPLICATIONS

This application relates to, and claims the benefit of the earlier filing date and priority of U.S. Provisional Patent Application No. 61/416,155, filed on Nov. 22, 2010, and entitled “Apparatus And Method For Valve Lash Adjustment.”

### FIELD OF THE INVENTION

The present invention relates generally to an apparatus and method for setting a lash space between a lost motion piston and an engine valve or other component of an internal combustion engine valve actuation system.

### BACKGROUND OF THE INVENTION

Engine valve actuation is required in order to produce positive power in an internal combustion engine and may be used to produce engine braking and/or exhaust gas recirculation (EGR). During positive power, one or more intake valves may be opened to admit air into a cylinder for combustion during the intake stroke of the piston. Also during positive power, one or more exhaust valves may be opened to allow combustion gases to escape from the cylinder during the exhaust stroke of the piston. During engine braking and/or EGR, one or more exhaust valves may be selectively opened to convert, at least temporarily, the engine into an air compressor for engine braking operation or to recirculate exhaust gas from the exhaust manifold back into the engine cylinder.

Auxiliary engine valve actuation may be provided for intake valves and exhaust valves during positive power, engine braking or other engine modes of operation. A lost motion system may be utilized to provide such auxiliary engine valve actuation. Such lost motion system may be provided in a fixed housing overlying the engine valves, for example, and include a hydraulically actuated lost motion piston. Alternatively, a lost motion piston may be integrated into the end of a rocker arm that is used to provide engine valve actuation. Regardless of where the lost motion piston resides, there may be a need to set a clearance, also known as lash space, between the outer end of the lost motion piston and the valve train element, such as the engine valve, that it actuates.

Tappet clearance or valve lash is the distance between a bottom surface of a lost motion piston or tappet and an upper surface of an engine valve, valve-bridge, or other underlying valve train element. The process of setting this clearance is commonly referred to in the art as “tappet setting,” “valve clearance setting,” or “valve lash setting.” Adjustment of the tappet clearance is an operation that may be carried out when the engine is initially assembled, from time to time during its normal operation, and after major servicing operation. Accurately setting the tappet clearance is vital to proper operation of the internal combustion engine because too little clearance will result in the improper sealing of the engine valve and could contribute to its early failure, whereas too much clearance could result in improper valve timing and excessive engine noise.

Tappet clearance may be adjusted by modifying the position of an upper stop against which the tappet is biased by a spring. This upper stop may be provided in the form of a screw that may be extended into the bore in which the tappet is disposed to decrease lash or retracted out of the same bore to increase lash. The screw may be provided with a lock nut to fix the position of the screw once proper lash is set.

To set the tappet clearance, the lock nut may be loosened and a feeler gauge may be inserted between the bottom surface of the tappet screw and an upper surface of the valve or valve-bridge. The mechanic then tightens or loosens the adjustment or tappet screw or bolt until the mechanic senses the correct amount of drag on the feeler gauge as it is pulled between the lower surface of the tappet and the valve or the valve-bridge. This process requires a high level of expertise in determining the appropriate feeler gauge clearance by sensing the drag on the feeler gauge.

When the engine is being assembled, it is also a common practice for an assembler to walk along and manually adjust the tappet clearance with feeler gauges as the engine travels on the assembly line. This adjustment may be carried out using a spanner, a screwdriver, a torque wrench, and a suitable feeler gauge. This method results in non-repeatable and inconsistent results as the skill of each assembler, his work habits, and his workstation directly affects the quality of the finished product.

After the correct tappet clearance is set, the lock nut may be tightened. The lock nut may be tightened to a specified torque. The adjustment or tappet screw must be held at the rotational position where the tappet clearance was set during tightening the lock nut. So, a normal socket-type torque wrench cannot be used since it would interfere with the screwdriver, wrench, or the adjustment or tappet screw. A special crow-foot torque wrench is usually used to enable the mechanic to hold the screw or bolt in position while tightening the lock nut.

The disadvantage of this technique for tappet setting or valve lash setting is not only the requirement for multiple tools, but also the difficulty in repeatedly setting the valve clearance within acceptable tolerances. The drag of the feeler gauge may be an acceptable way of measuring the gap for an experienced mechanic when the parts are new. The task, however, is not as easy for inexperienced personnel, particularly as the parts become worn. The feeler gauge may be pitted or otherwise distorted such that a feeler gauge tends to ride on the rough surfaces instead of measuring the actual gap. This method and equipment for tappet setting or valve lash setting may also suffer from an undesirable sensitiveness to environmental factors, such as, vibrations, dirt, variations in temperature etc. Moreover, this technique of setting tappet clearance may be overly time-consuming and costly for modern engine assembly and maintenance techniques, and prone to error.

Accordingly, it is an advantage of some, but not necessarily all, embodiments of the present invention to provide an improved apparatus and method for adjusting tappet clearance which overcomes deficiencies in the prior art. It is also an object of some, but not necessarily all, embodiments of the present invention to provide an improved apparatus and method for adjusting lost motion systems used to actuate internal combustion engine valves, which do not depend upon the use of feeler gauges or the like. It is a further object of some, but not necessarily all, embodiments of the present invention to provide an improved apparatus and method for adjusting internal combustion engine valves where the lash adjustment bolt or screw may be rotated with a tool to the required position to set the specified lash clearance, and the lock nut can be tightened with the same tool while the bolt or screw is held in the required position. It is a further object of some, but not necessarily all, embodiments of the present invention to provide an improved technique for accomplishing a simple and reliable valve lash setting, which is less sensitive to environmental factors and which provides a reliable, repeatable, and accurate result.

### SUMMARY OF THE INVENTION

Responsive to the foregoing challenges, Applicants have developed an innovative apparatus for setting clearance between a tappet screw and an engine valve or other components of an internal combustion engine comprising: a lock nut gauge, said lock nut gauge having a lock nut gauge body, a lock nut gauge well, a lock nut gauge central opening, and a lock nut gauge arm; a zero setting gauge, said zero setting gauge having a zero setting gauge central opening, a zero setting gauge shoulder adjacent to an upper surface of the lock nut gauge body, a notch provided in the zero setting gauge shoulder, and a zero setting gauge lower extension provided within the lock nut gauge well; a lash setting gauge, said lash setting gauge having a lash setting gauge central opening, a lash setting gauge shoulder adjacent to the zero setting gauge shoulder, a scroll channel provided in the lash setting gauge shoulder, and a lash setting gauge lower extension provided within the zero setting gauge central opening; a key having a lower post disposed in the zero setting gauge notch, and an upper post disposed within the lash setting gauge scroll channel; and a bit stem provided in the lash setting gauge central opening.

Applicants have also developed an innovative apparatus for adjusting a lash space, comprising: a lock nut gauge having a lock nut gauge central opening; a zero setting gauge having a key post bore, a lower extension extending into the lock nut gauge, and a zero setting gauge central opening; a lash setting gauge, said lash setting gauge having a lash setting gauge central opening, a scroll channel, and a lash setting gauge lower extension extending into the zero setting gauge central opening; a key extending between the zero setting gauge key post bore and the lash setting gauge scroll channel; and a bit stem provided in the lash setting gauge central opening.

It is to be understood that both the foregoing general description and the following detailed description are exemplary and explanatory only, and are not restrictive of the invention as claimed.

### BRIEF DESCRIPTION OF THE DRAWINGS

In order to assist the understanding of this invention, reference will now be made to the appended drawings, in which like reference characters refer to like elements. The drawings are exemplary only, and should not be construed as limiting the invention.

FIG. 1 is a three dimensional view of a tool for lash setting according to an embodiment of the invention when a key 700 is in a first position relative to a scroll channel 430.

FIG. 2 is a top view of a tool for lash setting according to an embodiment of the invention.

FIG. 3 is a cross-sectional view of the tool for lash setting taken along line B-B of FIG. 2.

FIG. 4 is a cross-sectional view of the tool for lash setting taken along line C-C of FIG. 2.

FIG. 5 is a cross-sectional view of the tool for lash setting taken along line D-D of FIG. 2.

FIG. 6 is an exploded isometric cross-sectional view of a bit stem and bit according to an embodiment of the invention.

FIG. 7 is an exploded isometric view of the tool for lash setting according to an embodiment of the invention.

FIG. 8 is an isometric view of the tool for lash setting according to an embodiment of the invention when a key 700 is in a second position relative to a scroll channel 430.

FIG. 9 is a top view of a tool for lash setting according to an embodiment of the invention in which a torque-responsive mechanism is incorporated in to the lock nut arm.

### DETAILED DESCRIPTION OF EMBODIMENTS OF THE INVENTION

As embodied herein, the present invention includes both apparatus and methods for adjusting the lash of an engine valve in an internal combustion engine. In particular, embodiments of the present invention may be used to set a lash space between a lost motion piston and an engine valve or other component of an internal combustion engine valve actuation system.

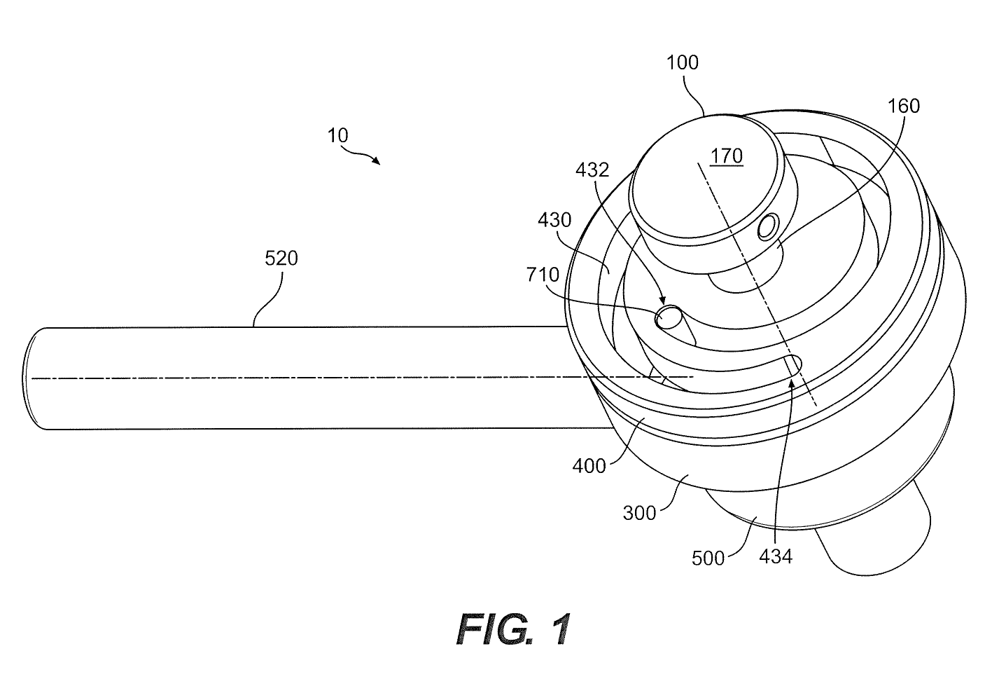

With reference to FIG. 1, the lash setting tool 10 may include a bit stem 100 nested within a lash setting gauge 400 which may be nested in a zero setting gauge 300 which may be nested in a lock nut gauge 500.

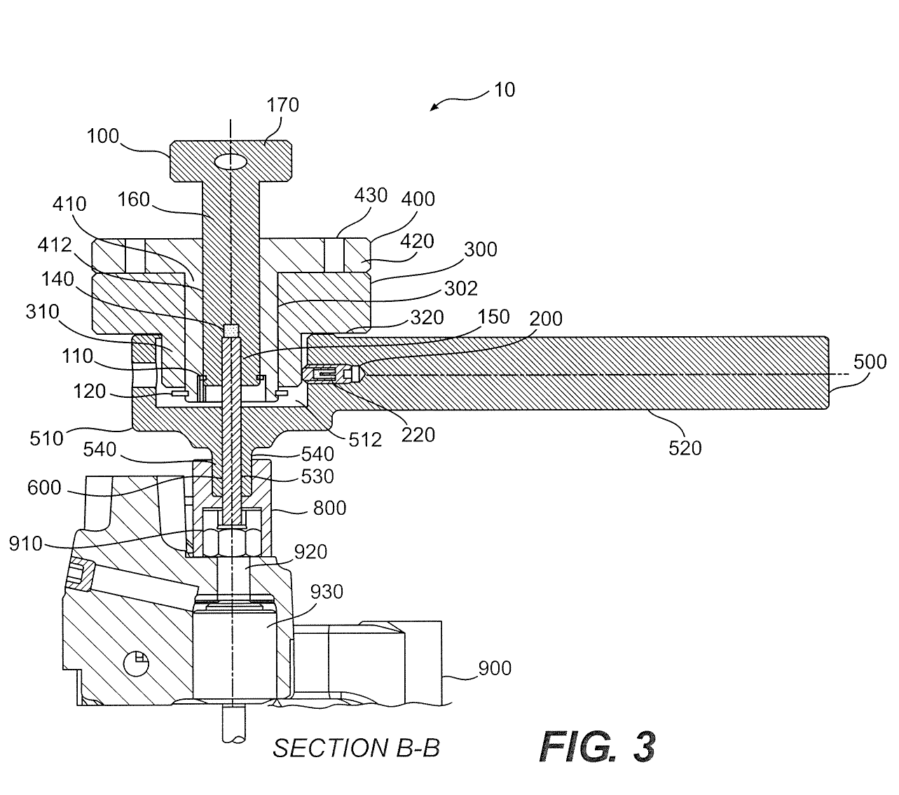

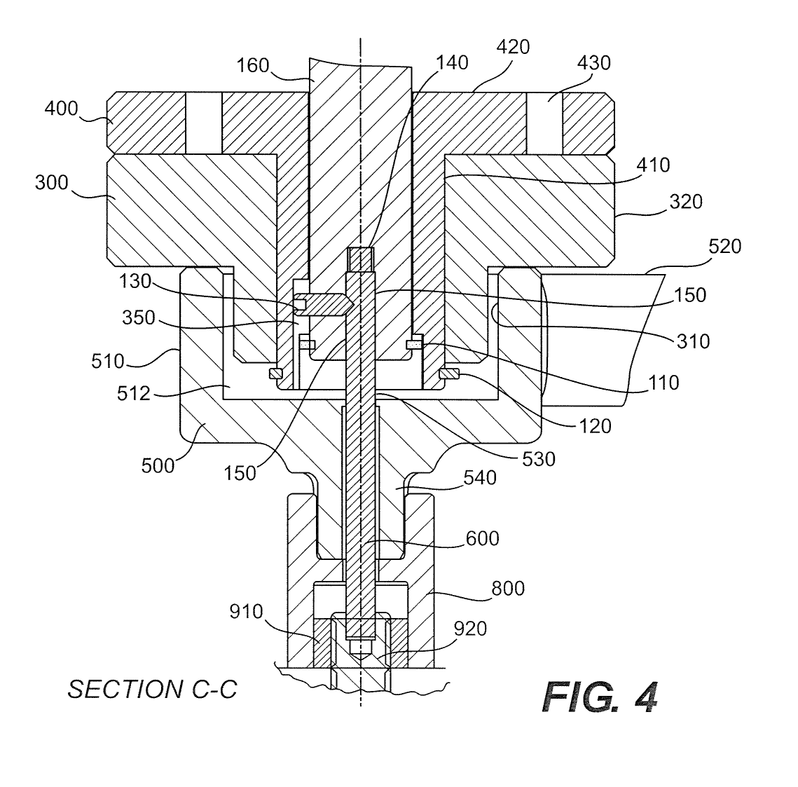

With reference to FIGS. 3-4, the lock nut gauge 500 may include a lock nut gauge body 510, an arm 520, and a central opening 530 including a well 512. A lower portion of the lock nut gauge body 510 may be provided with a socket adapter 540 which is adapted to engage a socket 800, which in turn may be adapted to engage a lock nut 910 provided on the upper end of an adjusting screw or tappet screw 920. The tappet screw 920 may be provided with a bit engaging upper end, such as a recessed hex end, flat screw end, cross-recessed end, Torx end, square end, or other bit end or the like, for engagement by a screw driving bit. In turn, the tappet screw may contact a tappet or slave piston 930 provided in a lost motion system. The lock nut arm 520 may be similar to any generally available torque or socket wrench handle. The lock nut arm 520 may also be detachably connected to the lock nut gauge body 510 for easy packing and/or storage.

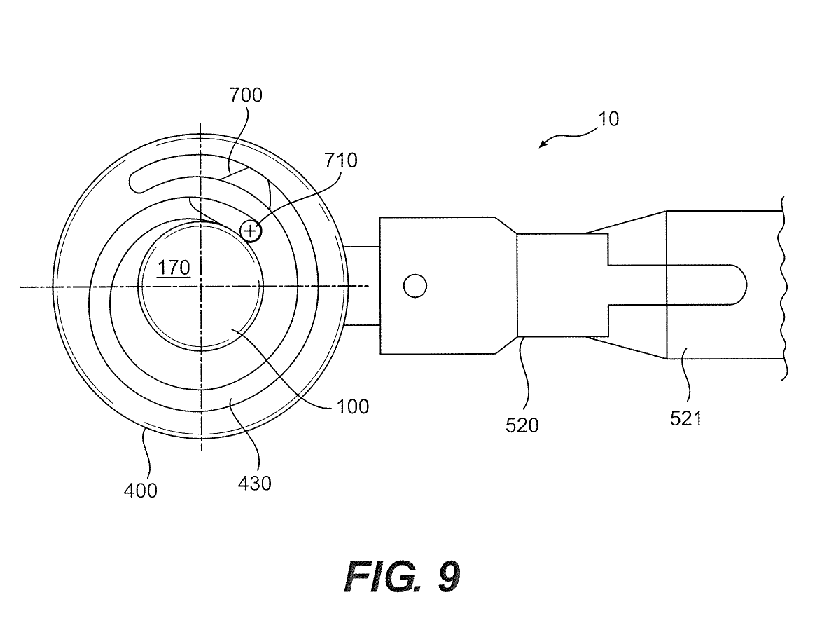

With reference to FIGS. 1 and 9, a torque-responsive mechanism 521 to tighten the lock nut 910 to the desired torque may be incorporated in to the lock nut arm 520. For example, the lock nut arm 520 may have a hollowed interior portion containing the torque-responsive mechanism 521 to tighten the lock nut 910 to the desired torque. The torque-responsive mechanism 521 may generate an audible, tactile and/or visible response once a designated torque has been applied to the lock nut 910. The portion of the lock nut arm 520 distal from the lock nut gauge body 510 may contain a lock nut dial or handle 522 for selecting a predetermined torque value for the lock nut 910. Such a torque-responsive mechanism 521 and a lock nut dial or handle 522 is well-known in the art and some examples of prior art torque wrenches are provided by the disclosure of Cutler et al., U.S. Pat. No. 6,945,144 (September 2005) and Shieh, U.S. Pat. No. 4,870,879 (October 1989), which are incorporated herein by reference. Incorporating torque-responsive mechanism 521 into the lock nut arm 520 may eliminate the need for a separate torque wrench to tighten the lock nut 910 to a desired torque or a device to verify the torque after the lock nut 910 has been torqued by the lock nut gauge 500.

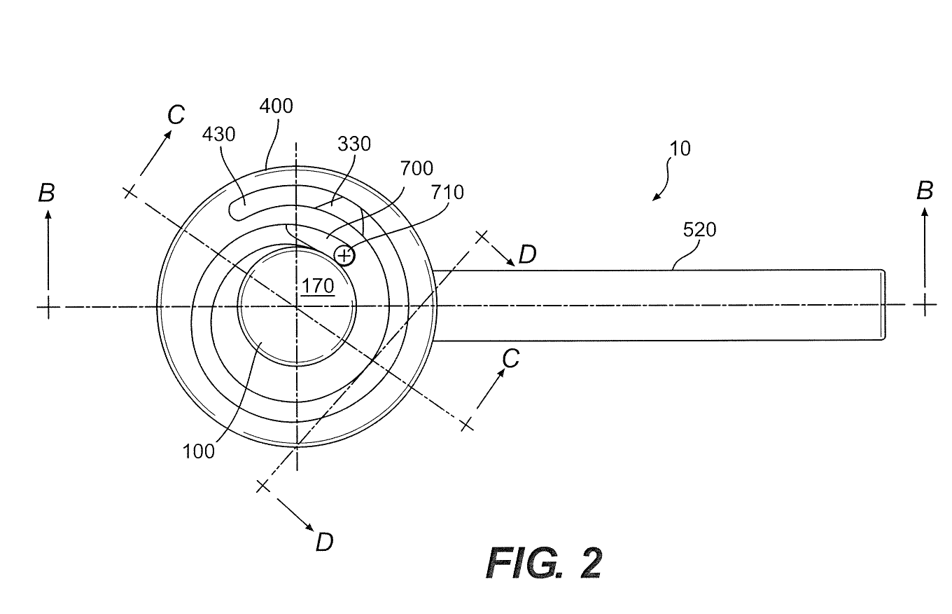

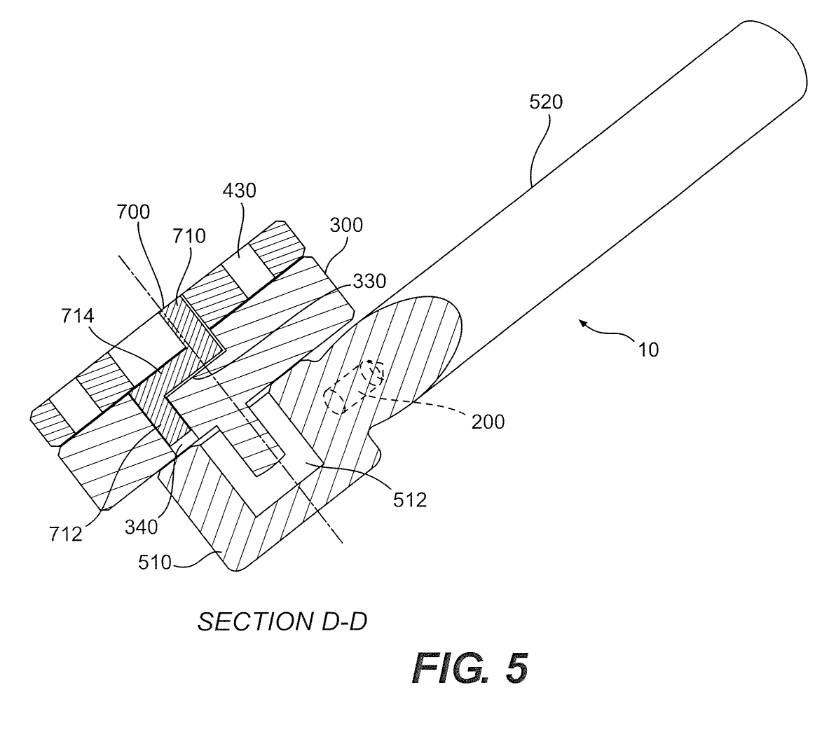

With reference to FIGS. 1 and 3, the zero setting gauge 300 may be disposed within a well portion 512 of a central opening 530 of a lock nut gauge body 510 of the lock nut gauge 500. The zero setting gauge 300 may include a lower extension 310 which extends into the well 512, a central opening 302, and an upper shoulder 320 which may rest upon an upper surface of the lock nut gauge body 510. An arm 520 may extend from the lock nut gauge body 510, and the arm may include a plunger recess 200. A plunger 210 may be disposed in the recess 200 and biased towards the zero setting gauge lower extension 310 by a spring or other biasing means 220. The plunger 210 may include a ball shaped end which may engage a mating indentation provided on the zero setting gauge lower extension 310. The zero setting gauge shoulder 320 may also include a notch 330 (see FIGS. 2 and 5) and a key post bore 340 (see FIG. 5) which are adapted to receive a center portion 714 and the lower post 712 of a key 700, respectively.

With renewed reference to FIGS. 1 and 3, the lash setting gauge 400 may include a lower extension 410 that extends into the zero setting gauge central opening 302, a lash setting gauge central opening 412, and a lash setting gauge shoulder 420. The lash setting gauge shoulder 420 may rest on the zero setting gauge shoulder 320, and the zero setting gauge 300 and the lash setting gauge 400 may be capable of being rotated relative to each other. With reference to FIG. 4, a first retaining ring 120 may be disposed near the bottom of the lash setting gauge lower extension 410 in a manner that prevents the lash setting gauge 400 from being pulled out of the zero setting gauge central opening 302. The lash setting gauge central opening 412 may be provided with a slot 350 adapted to receive the head portion of a set screw 130. The slot 350 and the set screw 130 may engage each other as described more fully below.

With reference to FIGS. 1-5 and 8, the lash setting gauge shoulder 420 may include a scroll channel 430 which extends from a top surface to a bottom surface of the shoulder. The scroll channel 430 may extend through a rotation of more than 360 degrees, either progressing from an inner position to an outer position when rotating counter-clockwise, or visa-versa. The key 700 may include a lower key post 712 which is disposed in and pivot-able relative to the key post bore 340 of the zero setting gauge 300. The key 700 may have a center portion 714 extending laterally between the lower key post 712 and an upper key post 710. The key center portion 714 may be disposed in the notch 330 of the zero lash setting gauge 300, and the shape of the notch may define the angle through which the key 700 may pivot relative to the zero setting gauge. The upper key post 710 may extend upward from the key center portion 714 into the scroll channel 430 and may slide within the scroll channel. It is further contemplated that the scroll channel 430 may have different shapes, such as, for example, helix, circle, semi-circle, and arc shapes without departing from the intended scope of the present invention.

With reference to FIGS. 1-3, a bit stem 100 may be disposed within the lash setting gauge 400. The bit stem 100 may include an upper bit stem head 170 and a lower bit stem body 160. The bit stem body 160 may be disposed in the lash setting gauge central opening 412 and may have a bit stem pocket 150 which extends upward from a lower end of the stem body. A magnet 140 may be provided in the bit stem pocket 150, which magnet may be adapted to hold a bit 600 in place in the bit stem pocket. A set screw 130 may extend through the bit stem body 160 and engage the bit 600 so that the bit does not rotate relative to the bit stem 100. The head of the set screw 130 may extend into the slot 350 provided in the lash setting gauge central opening 412 such that the rotation of either the bit stem 100 or the lash setting gauge 400 causes the other to rotate in a similar fashion. The bit 600 may have any type of screw-driving bit end, such as a hex end for example, which may be received in the tappet screw 920. The tappet screw 920 may provide an upper stop and set the lash for a tappet or slave piston or other lost motion element 930. The bit stem body 160 may also have a second retaining ring disposed near the bottom of the bit stem body in a manner that prevents the bit stem 100 from being pulled out of the lash setting gauge central opening 412.

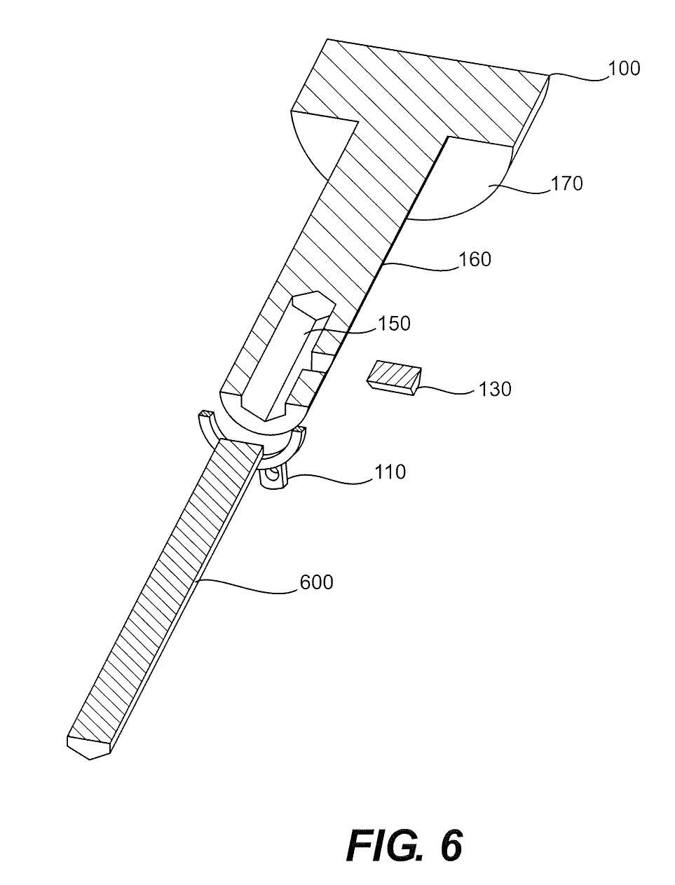

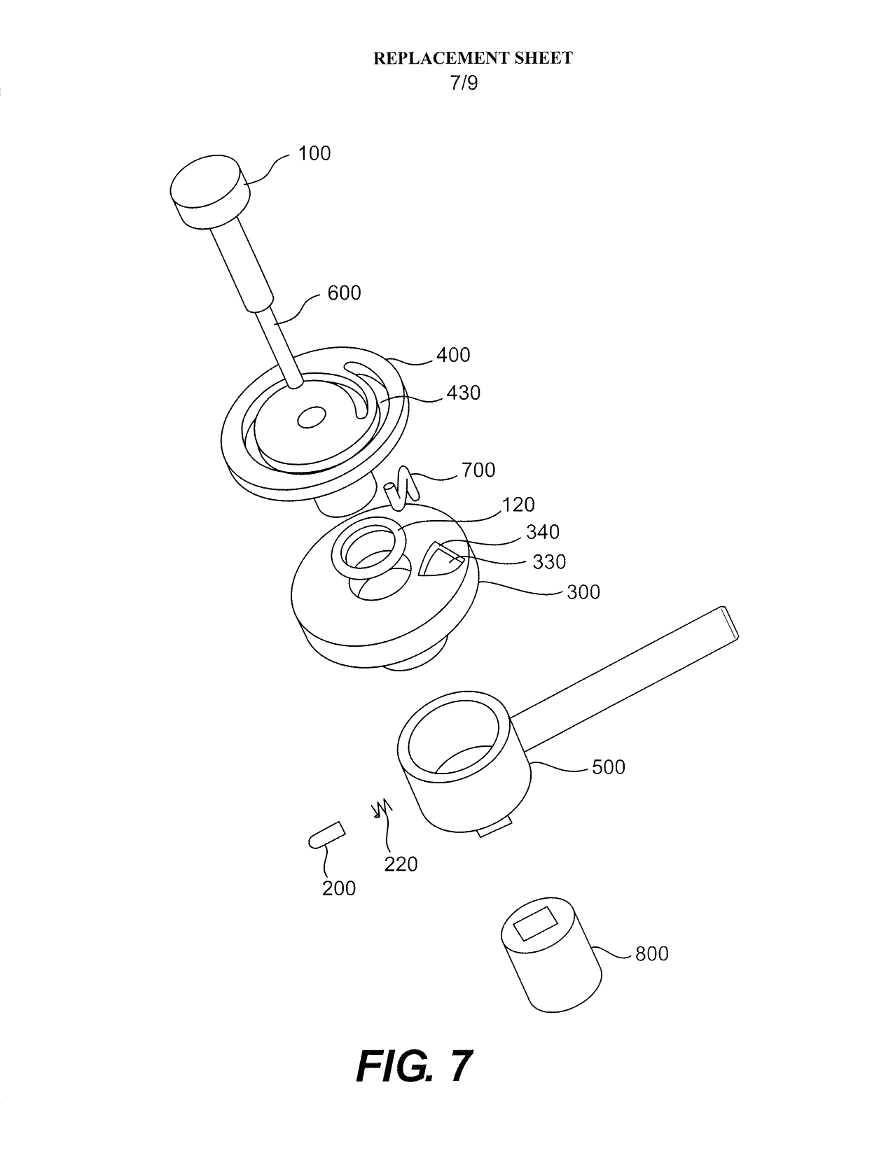

With reference to FIG. 6, in an alternative embodiment, the bit 600 may have a cross-sectional shape, such as hexagonal, which mates with a like-shaped bit stem pocket 150. In such cases, the bit 600 will not rotate relative to the bit stem 100 whether or not the set screw 130 is provided. In yet another alternative embodiment, shown in FIG. 7, the bit stem 100 and the bit 600 may be integrally formed.

The tool 10 may be used for setting clearance between a lost motion tappet or piston and an engine valve or other components of an internal combustion engine, as follows. Initially, the relevant piston of the engine may be provided at its top dead center (“TDC”) position to ensure that the engine valve may be fully closed and the lost motion piston whose tappet clearance or valve lash setting is to be adjusted may be in the correct orientation for the valve clearance setting process. Thereafter, as shown in FIG. 3, the socket 800 may be placed on the lock nut 910 and the bit 600 may engage the tappet screw 920. Next, the lock nut 910 may be backed-off by half a turn, more or less, by turning the lock nut arm 520 counter-clockwise. This may loosen the lock nut 910 and permit rotation of the adjusting screw or tappet screw 920.

Next, with reference to FIG. 1, the bit stem 100 may be rotated clockwise so that the key bit 600 is received into the mating upper end of the adjusting screw or tappet screw 920. The bit key stem 100 may be rotated while holding the lock nut gauge arm 520 to ensure that the lock nut 910 is not tightened as a result of rotating the bit stem. As shown in FIG. 3, the bit stem 100 may continue to be rotated clockwise so that the tappet screw 920 moves downward until there is zero “0” gap between the tappet screw and the valve tip or other valve train element.

With reference to FIG. 1, next the zero setting gauge 300 may be rotated clockwise until the key guide 700 comes to a “0” position at the first end 432 of the scroll channel 430. Because the rotation of the zero (“0”) setting gauge 300 does not cause the bit 600 to rotate, the adjusting screw or tappet screw 920 is not moved from its zero lash setting, shown in FIG. 3.

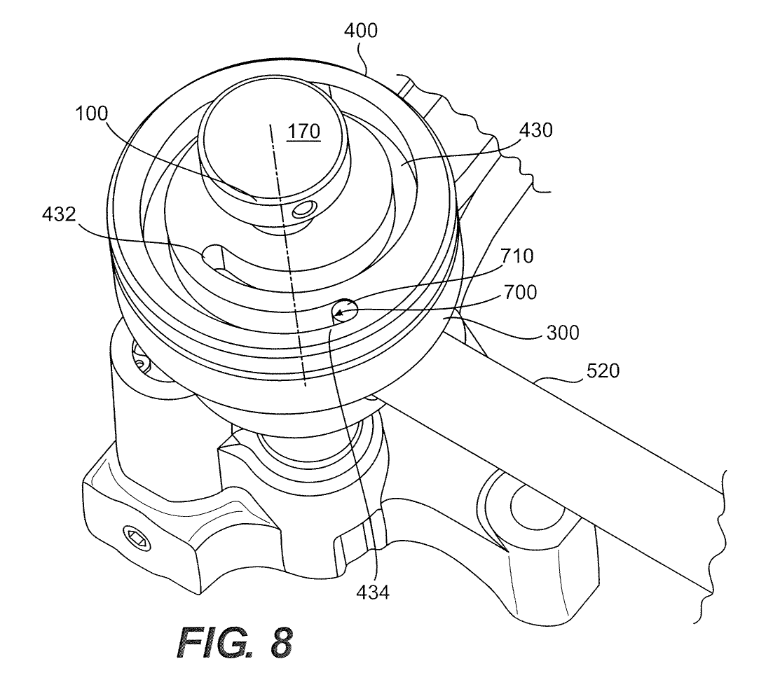

As shown in FIG. 3, after the upper key post 710 is placed in the “0” position at the first end 432 of the scroll channel, the bit stem 100 may be rotated counter-clockwise while holding the zero lash setting gauge 300 in a fixed position. As the bit stem 100 rotates counter-clockwise, the lash setting gauge 400 may also rotate counter-clockwise with the bit stem 100 due to the head of the set screw 130 engaging the wall of the slot 350 (see FIG. 4). The counter-clockwise rotation of the bit stem 100 rotates the bit 600 counter-clockwise, thereby backing the adjusting screw or tappet screw 920 away from the tappet or slave piston 930. As the bit stem 100 and the lash setting gauge 300 are rotated counter-clockwise, the key 700 travels with the lash setting gauge causing the upper key post 710 to slide through the scroll channel 430 until the upper post reaches the second end 434 of the scroll channel, as shown in FIG. 8. The amount by which the adjusting screw or tappet screw 920 is backed out corresponds to the length of the scroll channel 430 or the distance traveled by the key 700 from the first end to the second end of the scroll channel 430.

Thereafter, the bit stem 100 may be held in position and the lock nut gauge arm 520 may be rotated clockwise to tighten the lock nut 910. The lock nut arm 520 containing the torque-responsive mechanism 521 may be rotated to tighten the lock nut 910 to the desired torque. If the lock nut arm 520 does not contain the torque-responsive mechanism 521 then the lock nut arm 520 may be rotated to tighten the lock nut 910 and the torque may then be checked with any suitable device to verify the torque. Else, a torque wrench may be used to tighten the lock nut 910 to the desired torque.

It will be apparent to those skilled in the art that variations and modifications of the present invention can be made without departing from the scope or spirit of the invention. For example, the components and arrangement of the tool 10, as shown in FIGS. 1-8 are for exemplary purposes only. It is contemplated that other components necessary for a properly operating tool may be provided and that the arrangement of the components of the tool may be varied so long as the resulting tool falls within the scope of the claims to the tool. For example, the components of the tool and their arrangement may vary depending on a variety of factors, such as, for example, the engine design, tappet clearance, or the valve lash setting. In another example, it is contemplated that alternative means for causing the bit stem and the zero setting gauge to rotate together may be utilized without departing from the intended scope of the invention. Thus, it is intended that the present invention cover all such modifications and variations of the invention, provided they come within the scope of the appended claims and their equivalents.

What is claimed is:

1. An apparatus for setting clearance between a tappet screw and an engine valve or other components of an internal combustion engine comprising:
a lock nut gauge, said lock nut gauge having a lock nut gauge body, a lock nut gauge well, a lock nut gauge central opening, and a lock nut gauge arm;
a zero setting gauge, said zero setting gauge having a zero setting gauge central opening, a zero setting gauge shoulder adjacent to an upper surface of the lock nut gauge body, a notch provided in the zero setting gauge shoulder, and a zero setting gauge lower extension provided within the lock nut gauge well;
a lash setting gauge, said lash setting gauge having a lash setting gauge central opening, a lash setting gauge shoulder adjacent to the zero setting gauge shoulder, a scroll channel provided in the lash setting gauge shoulder, and a lash setting gauge lower extension provided within the zero setting gauge central opening;
a key having a lower post disposed in the zero setting gauge notch, and an upper post disposed within the lash setting gauge scroll channel; and
a bit stem provided in the lash setting gauge central opening.

2. The apparatus of claim 1, further comprising a lock nut socket engaging a lower portion of the lock nut gauge.

3. The apparatus of claim 1, wherein the scroll channel extends through more than 360 degrees of rotation.

4. The apparatus of claim 1, wherein the scroll channel extends through less than 360 degrees of rotation.

5. The apparatus of claim 1, further comprising:
a bit stem pocket provided in a lower portion of the bit stem; and
a magnet disposed in the bit stem pocket.

6. The apparatus of claim 5, further comprising:
a plunger recess extending into the lock nut gauge arm from the lock nut gauge well;
a plunger provided in the plunger recess; and
a means for biasing the plunger out of the plunger recess,
wherein the zero setting gauge lower extension includes an indent engaged by the plunger.

7. The apparatus of claim 6, further comprising:
a bit extending from a lower portion of the bit stem; and
a set screw extending through the lower portion of the bit stem to engage said bit.

8. The apparatus of claim 7, further comprising a slot provided in the lash setting gauge central opening, wherein said set screw extends into said slot.

9. The apparatus of claim 8 wherein the lower key post and the upper key post are laterally offset from each other.

10. The apparatus of claim 9 further comprising a first retaining ring disposed at a lower portion of the lash setting gauge and a second retaining ring disposed at a lower portion of the bit stem.

11. The apparatus of claim 1, further comprising:
a plunger recess extending into the lock nut gauge arm from the lock nut gauge well;
a plunger provided in the plunger recess; and
a means for biasing the plunger out of the plunger recess,
wherein the zero setting gauge lower extension includes an indent engaged by the plunger.

12. The apparatus of claim 1, further comprising:
a bit extending from a lower portion of the bit stem; and
a set screw extending through the lower portion of the bit stem to engage said bit.

13. The apparatus of claim 1, further comprising:
a slot provided in the lash setting gauge central opening; and
a set screw extending into said slot.

14. The apparatus of claim 1 wherein the lower key post and the upper key post are laterally offset from each other.

15. The apparatus of claim 1 further comprising a first retaining ring disposed at a lower portion of the lash setting gauge and a second retaining ring disposed at a lower portion of the bit stem.

16. The apparatus of claim 1, further comprising a torque-responsive mechanism incorporated into the lock nut gauge arm.

17. An apparatus for adjusting a lash space, comprising:
a lock nut gauge having a lock nut gauge central opening;
a zero setting gauge having a key post bore, a lower extension extending into the lock nut gauge, and a zero setting gauge central opening;
a lash setting gauge, said lash setting gauge having a lash setting gauge central opening, a scroll channel, and a lash setting gauge lower extension extending into the zero setting gauge central opening;
a key extending between the zero setting gauge key post bore and the lash setting gauge scroll channel; and
a bit stem provided in the lash setting gauge central opening.

18. The apparatus of claim 16, further comprising a lock nut socket engaging a lower portion of the lock nut gauge.

19. The apparatus of claim 16, further comprising:
a bit stem pocket provided in a lower portion of the bit stem; and
a magnet disposed in the bit stem pocket.

20. The apparatus of claim 16, further comprising:
a lock nut gauge arm;
a plunger recess extending into the lock nut gauge arm;
a plunger provided in the plunger recess; and
a means for biasing the plunger out of the plunger recess into the zero setting gauge.

21. The apparatus of claim 16, further comprising:
a bit extending from the lower portion of the bit stem; and
a set screw extending through the lower portion of the bit stem, said set screw adapted to engage a bit.

22. The apparatus of claim 20, further comprising a slot provided in the lash setting gauge central opening, wherein said set screw extends into said slot.

23. The apparatus of claim 16 wherein the key includes a lower key post and an upper key post laterally offset from each other.

24. The apparatus of claim 16 further comprising a first retaining ring disposed at a lower portion of the lash setting gauge and a second retaining ring disposed at a lower portion of the bit stem.

25. The apparatus of claim 16, further comprising a torque-responsive mechanism incorporated into the lock nut gauge arm.
